(19) United States
(12) Patent Application Publication
(10) Pub. No.: US 2007/0171477 A1
(43) Pub. Date: Jul. 26, 2007

(54) Method of printing image and apparatus operable to execute the same, and method of processing image and apparatus operable to execute the same

(76) Inventor: Toshie Kobayashi, Shiojin-Shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/657,418

(22) Filed: Jan. 23, 2007

(30) Foreign Application Priority Data
Jan. 23, 2006 (JP) P2006-013611

(51) Int. Cl. G06K 15/00

(52) U.S. Cl. 358/3.24

(57) ABSTRACT

Image data obtained by capturing an image including a human is received. A facial impression which is given by a human face is designated. A prescribed component of a human face included in the image data is detected. A part of the image data corresponding to the prescribed component is adjusted in accordance with the designated facial impression to obtain adjusted image data. An image is printed based on the adjusted image data.

### BACKGROUND

1. Technical Field

The present invention relates to a technology that prints an image captured so as to include a human.

2. Related Art

Various printers including an ink jet printer have an advantage that a color image can be simply and conveniently printed without needing a large apparatus and thus they are widely used as an image output device. Further, in such printers, in order to enable simple and convenient printing with sufficient quality, there are developed various technologies such as increasing the number of ink color, increasing the number of printable dot size, improvement of image processing technique, and so on. Such technologies are disclosed in, for example, Japanese Patent Publication Nos. 10-175318A and 2000-6445A (JP-A-10-175318 and JP-A-2000B445). As a result, at present, an image captured by a digital camera can be printed with high quality comparable to a color photograph printed with a silver salt film. Further, a subtle difference in impression due to a slight difference in how light enters can be expressed.

However, when an image including a human is captured and printed, the following problem, which was not observed in the preceding printer, occurs. That is, even though image capturing is performed in the same manner, a variation in expression occurs. Specifically, an expression of the human may give a childlike impression or may give an adult impression unexpectedly. This may act in a favorable way, but it may act for the worse. For example, a photograph, which is to be used for a resume, may give a childlike impression. This problem does not occur until reproducibility of a printer has been improved nowadays, Accordingly, it can be considered that the above problem occurs since the reproducibility of the printer is improved so that a subtle difference in impression due to a slight difference in how light enters can be expressed.

### SUMMARY

It is therefore one advantageous aspect of the invention to provide a technology that enables printing in which a face expression of a human is always given with a desired appropriate impression.

According to one aspect of the invention, there is provided a printing method, comprising:

receiving image data obtained by capturing an image including a human;

designating a facial impression which is given by a human face;

detecting a prescribed component of a human face included in the image data;

adjusting a part of the image data corresponding to the prescribed component in accordance with the designated facial impression to obtain adjusted image data; and

printing an image based on the adjusted image data.

The printing method may further comprise analyzing the image data to extract a part including the human face, wherein the prescribed component is detected in the extracted human face.

The facial impression may be designated by selecting one of a plurality of facial impressions each of which is stored in a storage in advance.

The facial impression may be designated as a combination of values on a plurality of coordinate axes each of which represents opposite facial impressions as positive and negative values.

According to one aspect of the invention, there is provided a printing apparatus comprising:

a receiver, operable to receive image data obtained by capturing an image including a human;

a designator, operable to designating a facial impression which is given by a human face;

a detector, operable to detect a prescribed component of a human face included in the image data;

an adjuster, operable to adjust a part of the image data corresponding to the prescribed component in accordance with the designated facial impression to obtain adjusted image data; and

a printing section, operable to print an image based on the adjusted image data.

According to one aspect of the invention, there is provided an image processing method, comprising:

receiving image data obtained by capturing an image including a human;

designating a facial impression which is given by a human face;

detecting a prescribed component of a human face included in the image data;

adjusting a part of the image data corresponding to the prescribed component in accordance with the designated facial impression to obtain adjusted image data; and

generating control data adapted to be used in a printing apparatus, based on the adjusted image data.

According to one aspect of the invention, there is provided an image processing apparatus, comprising:

a receiver, operable to receive image data obtained by capturing an image including a human;

a designator, operable to designating a facial impression which is given by a human face;

a detector, operable to detect a prescribed component of a human face included in the image data;

an adjuster, operable to adjust a part of the image data corresponding to the prescribed component in accordance with the designated facial impression to obtain adjusted image data; and

a generator, operable to generate control data adapted to be used in a printing apparatus, based on the adjusted image data.

### BRIEF DESCRIPTION OF THE DRAWINGS

FIG. 1 is a schematic view showing a printing apparatus according to a first embodiment of the invention.

FIG. 2 is a perspective view showing an external appearance of the printing apparatus.

FIG. 3 is a perspective view showing a state that a table cover of the printing apparatus is opened.

FIG. 4 is a perspective view showing a state that a scanner section of the printing apparatus is lifted up.

FIG. 5 is a schematic view showing an internal configuration of the printing apparatus.

FIG. 6 is a schematic view showing nozzles of printing heads in a printer section of the printing apparatus.

FIG. 7 is a flowchart showing an image print processing executed in the printing apparatus.

FIG. 8 shows a screen for setting facial impression which is displayed in a control panel of the printing apparatus.

FIG. 9 is a diagram for explaining a color conversion table used in a color conversion processing in the image copy processing.

FIG. 10 is a diagram showing a part of a dither matrix used in a halftoning in the image copy processing.

FIG. 11 is a diagram showing how to judge whether dots are formed for each pixel with reference to the dither matrix.

FIG. 12 is a flowchart showing a facial impression adjustment executed in the printing apparatus.

FIG. 13 shows a portion of a human face extracted from image data when the facial impression adjustment is executed.

FIG. 14 is a diagram for explaining how are positions of facial components in the human face determined when the facial impression adjustment is executed.

FIG. 15 shows how the facial components are adjusted by the facial impression adjustment in a case where “lively” is selected as the facial impression.

FIG. 16 shows how the facial components are adjusted by the facial impression adjustment in a case where “lovely” is selected as the facial impression.

FIG. 17 shows how the facial components are adjusted by the facial impression adjustment in a case where “intellectual” is selected as the facial impression.

FIG. 18 shows how the facial components are adjusted by the facial impression adjustment in a case where “gentle” is selected as the facial impression.

FIG. 19 shows a screen for setting facial impression which is displayed in a control panel of a printing apparatus according to a second embodiment of the invention.

FIG. 20 shows how the facial components are adjusted by facial impression adjustment executed in the printing apparatus of FIG. 19.

### DETAILED DESCRIPTION OF EXEMPLARY EMBODIMENTS

Exemplary embodiments of the invention will be described below in detail with reference to the accompanying drawings.

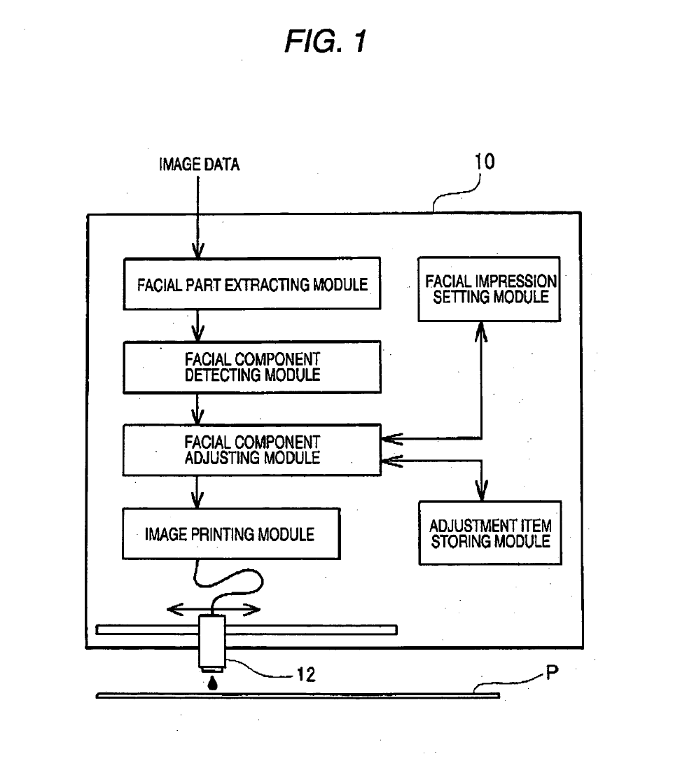

FIG. 1 shows a printing apparatus 10 according to a first embodiment of the invention provided with a printing head 12 operable to eject ink droplets. The printing apparatus 10 is a so-called ink jet printer in which, while the printing head 12 reciprocates above a printing medium P, ink droplets are ejected so as to form ink dots on the printing medium P, thereby printing an image.

In this embodiment, individual modules, such as facial impression setting module, adjustment item storing module, facial part extracting module, facial component detecting module, facial component adjusting module, and the like, are incorporated. Moreover, the term “module” refers to a functional feature corresponding to a series of processing to be performed internally when the printing apparatus 10 prints an image. Accordingly, the module may be implemented using a part of a program, a logical circuit having a specific function, or a combination thereof.

In the printing apparatus 10 shown in FIG. 1, when image data of an image to be printed is received, the following image processing is performed by the individual modules, then the printing head 12 is driven, and subsequently the image is printed on the printing medium P. First, prior to printing of the image, a facial impression is set in the facial impression setting module. The term “facial impression” refers to an impression given by a human face. For example, impressions, such as “lively”, “gentle”, “young”, “adult”, “modest”, and a “positive”, may be exemplified.

Next, when the image data of the image to be printed is received, the facial part extracting module analyzes the image data so as to extract a portion of the human face. The facial component detecting module detects prescribed components (for example, eye, lip, eyebrows, cheeks, or the like) from the extracted face. Further, the adjustment item storing module stores, in advance, items for adjusting the prescribed components in association with a facial impression. When the prescribed component detected by the facial component detecting module is received, the component is adjusted according to the set facial impression with reference to the adjustment item. Image data having the component adjusted in such a manner is supplied to an image printing module and is converted into a signal for driving the printing head 12. Then, the image is printed on the printing medium P. If the image is printed in such a manner, printing can be performed such that a desired appropriate impression is constantly given. Hereinafter, the printing apparatus 10 will be described in detail.

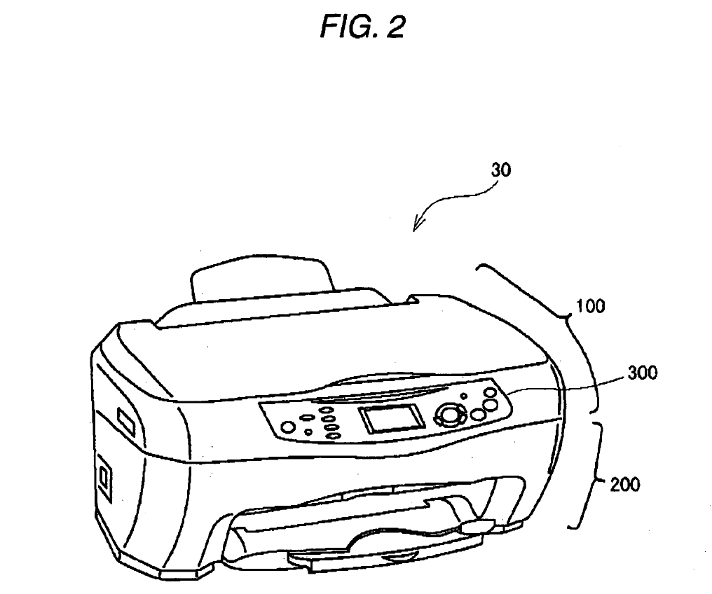

As shown in FIG. 2, the printing apparatus 10 of this embodiment includes a scanner section 100, a printer section 200, and a control panel 300 that controls operations of the scanner section 100 and the printer section 200. The scanner section 100 has a scanner function of reading a printed image and generating image data. The printer section 200 has a printer function of receiving the image data and printing an image on a printing medium. Further, if an image (original image) read by the scanner section 100 is output from the printer section 200, a copier function can be realized. That is, the printing apparatus 10 of this embodiment is a so-called scanner/printer/copier hybrid apparatus (hereinafter, referred to as SPC hybrid apparatus) that can solely realize the scanner function, the printer function, and the copier function.

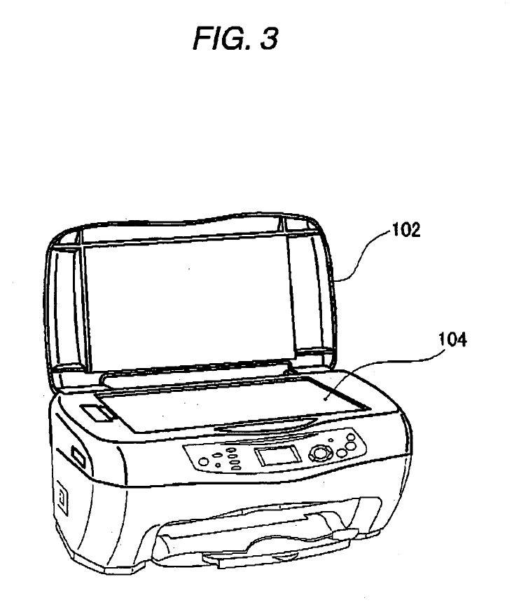

As shown in FIG. 3, when a table cover 102 is opened upward, a transparent original table 104 is provided, and various mechanisms, which will be described below, for implementing the scanner function are mounted therein. When an original image is read, the table cover 102 is opened, and the original image is placed on the original table 104. Next, the table cover 102 is closed, and a button on the control panel 300 is operated. Then, the original image can be directly converted into image data.

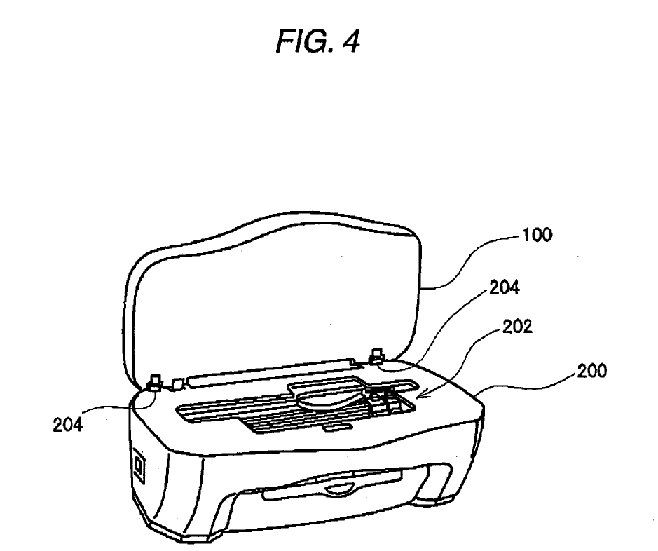

Further, the entire scanner section 100 is housed in a case as a single body, and the scanner section 100 and the printer section 200 are coupled to each other by a hinge mechanism 204 (see FIG. 4) on a rear side of the printing apparatus 10. For this reason, only the scanner section 100 can rotate around the hinge when a front side of the scanner section 100 is lifted.

As shown in FIG. 4, in the printing apparatus 10 of this embodiment, when the front side of the scanner section 100 is lifted, the top face of the printer section 200 can be exposed. In the printer section 200, various mechanisms, which will be described below, for implementing the printer function, are provided. Further, in the printer section 200, a control circuit 260, which will be described below, for controlling the overall operation of the printing apparatus 10 including the scanner section 100, and a power supply circuit (not shown) for supplying power to the scanner section 100 or the printer section 200 are provided. In addition, as shown in FIG. 4, an opening portion 202 is provided on the upper face of the printer section 200, through which replacement of consumables such as ink cartridges, treatment of paper jam, and easy repair can be simply executed.

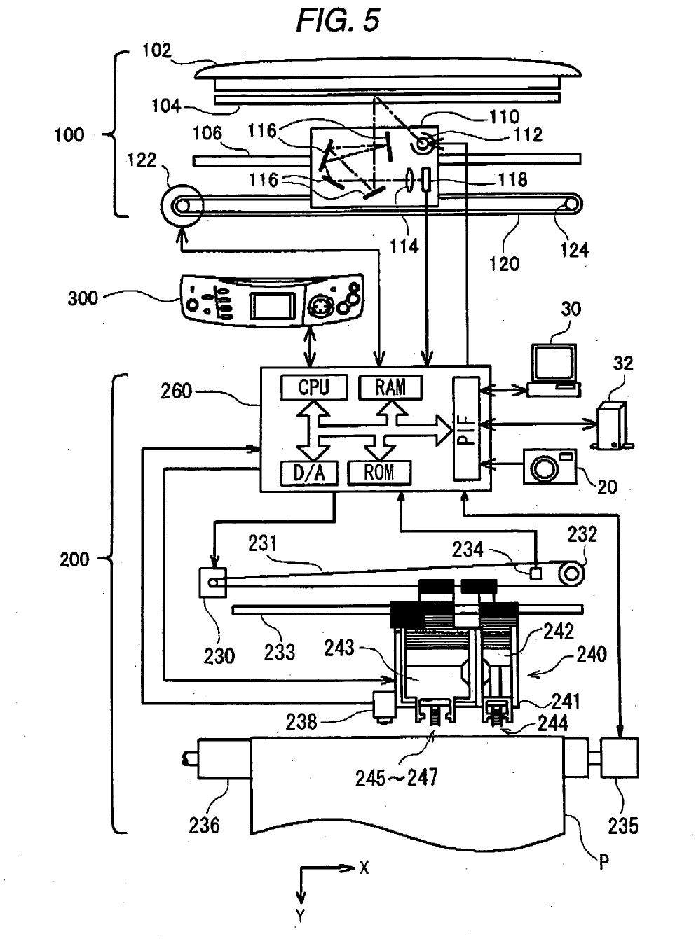

Next, a description is given of the internal constructions of the scanner section 100 and the printer section 200 with reference to FIG. 5.

The scanner section 100 includes: the transparent original table 104 on which a printed original color image is set; a table cover 102 which presses a set original color image; a scanner carriage 110 for reading an original color image; a carriage belt 120 to move the scanner carriage 110 in the primary scanning direction X; a drive motor 122 to supply power to the carriage belt 120; and a guide shaft 106 to guide movements of the scanner carriage 110. In addition, operations of the drive motor 122 and the scanner carriage 110 are controlled by the control circuit 260 described later.

The scanner section 100 includes a transparent original table 104, on which a original image is set, a table cover 102 that presses the set original image, a reading carriage 110 that reads the set original image, a driving belt 120 that moves the reading carriage 110 in a reading direction (main scanning direction), a driving motor 122 that supplies power to the driving belt 120, and a guide shaft 106 that guides the movement of the reading carriage 110. Further, the operation of the driving motor 122 or the reading carriage 110 is controlled by a control circuit 260 described below.

As the drive motor 122 is rotated under control of the control circuit 260, the motion thereof is transmitted to the scanner carriage 110 via the carriage belt 120. As a result, the scanner carriage 110 is moved in the primary scanning direction X in response to the turning angle of the drive motor 122 while being guided by the guide shaft 106. Also, the carriage belt 120 is adjusted in a state that proper tension is always given thereto by an idler pulley 124. Therefore, it becomes possible to move the scanner carriage 110 in the reverse direction by the distance responsive to the turning angle if the drive motor 122 is reversely rotated.

Alight source 112, a lens 114, mirrors 116, and a CCD sensor 118 are incorporated in the interior of the scanner carriage 110. Light from the light source 112 is irradiated onto the original table 104 and is reflected from an original color image set on the original table 104. The reflected light is guided to the lens 114 by the mirror 116, is condensed by the lens 114 and is detected by the CCD sensor 118. The CCD 118 is composed of a linear sensor in which photo diodes for converting the light intensity to electric signals are arrayed in the direction orthogonal to the primary scanning direction X of the scanner carriage 110. For this reason, while moving the scanner carriage 110 in the primary scanning direction X, light of the light source 112 is irradiated onto an original color image, and the intensity of the reflected light is detected by the CCD sensor 118, whereby it is possible to obtain electric signals corresponding to the original color image.

Further, the light source 112 is composed of light emitting diodes of three colors of RGB, which is able to irradiate light of R color, G color and B color at a predetermined cycle by turns. In response thereto, reflected light of R color, G color and B color can be detected by the CCD sensor 118 by turns. Generally, although red portions of the image reflect light of R color, light of G color and B color is hardly reflected. Therefore, the reflected light of R color expresses the R component of the image. Similarly, the reflected light of G color expresses the G component of the image, and the reflected light of B color expresses the B component of the image. Accordingly, light of three colors of RGB is irradiated onto an original color image while being changed at a predetermined cycle, If the intensifies of the reflected light are detected by the CCD sensor 118 in synchronization therewith, it is possible to detect the R component, G component, and B component of the original color image, wherein the color image can be read. In addition, since the scanner carriage 110 is moving while the light source 112 is changing the colors of light to be irradiated, strictly speaking, the position of an image for which the respective components of RGB are detected will differ corresponding to the amount of movement of the scanner carriage 110. However, the difference can be adjusted by an image processing after the respective components are read.

The printer section 200 is provided with the control circuit 260 for controlling the operations of the entirety of the printing apparatus 10, a printer carriage 240 for printing images on a printing medium P, a mechanism for moving the printer carriage 240 in the primary scanning direction X, and a mechanism for feeding the printing medium P.

The printer carriage 240 is composed of an ink cartridge 242 for accommodating K ink, an ink cartridge 243 for accommodating various types of ink of C ink, M ink, and Y ink, and a head unit 241 secured on the bottom face. The head unit 241 is provided with an head for ejecting ink drops per ink If the ink cartridges 242 and 243 are mounted in the printer carriage 240, respective ink in the cartridges are supplied to the printing heads 244 through 247 of respective ink through a conduit (not illustrated).

The mechanism for moving the printer carriage 240 in the primary scanning direction X is composed of a carriage belt 231 for driving the printer carriage 240, a carriage motor 230 for supplying power to the carriage belt 231, a tension pulley 232 for applying proper tension to the carriage belt 231 at all times, a carriage guide 233 for guiding movements of the printer carriage 240, and a reference position sensor 234 for detecting the reference position of the printer carriage 240. If the carriage motor 230 is rotated under control of a control circuit 260 described later, the printer carriage 240 can be moved in the primary scanning direction X by the distance responsive to the turning angle. Further, if the carriage motor 230 is reversed, it is possible to cause the printer carriage 240 to move in the reverse direction.

The mechanism for feeding a printing medium P is composed of a platen 236 for supporting the printing medium P from the backside and a medium feeding motor 235 for feeding paper by rotating the platen 236. If the medium feeding motor 235 is rotated under control of a control circuit 260 described later, it is possible to feed the printing medium P in a secondary scanning direction Y by the distance responsive to the turning angle.

The control circuit 260 is composed of a ROM, a RAM, a DIA converter for converting digital data to analog signals, and further an interface PIF for peripheral devices for communications of data between the CPU and the peripheral devices, including the CPU. The control circuit 260 controls operations of the entirety of the printing apparatus 10 and controls these operations through communications of data between the light source 112, the drive motor 122 and the CCD 118, which are incorporated in the scanner section 100.

In addition, the control circuit 260 controls supplying drive signals to the printing heads 244 through 247 of respective colors and ejecting ink drops while causing the printer carriage 240 to be subjected to primary scanning and secondary scanning by driving the carriage motor 230 and the medium feeding motor 235. The drive signals supplied to the printing heads 244 through 247 are generated by reading image data from a computer 20 and a digital camera 30, and executing an image processing described later. As a matter of course, by applying an image processing to the RGB image data read by the scanner section 100, it is possible to generate the drive signals. Thus, under the control of the control circuit 260, ink dots of respective colors are formed on a printing medium P by ejecting ink drops from the printing heads 244 through 247 while causing the printer carriage 240 to be subjected to the primary scanning and secondary scanning, whereby it becomes possible to print a color image. As a matter of course, instead of executing an image processing in the control circuit 260, it is possible to drive the printing heads 244 through 247 by receiving image-processed data from the computer 20 while causing the printer carriage 240 to be subjected to the primary scanning and secondary scanning in compliance with the data.

Also, the control circuit 260 is connected so as to receive data from and transmit the same to the control panel 300, wherein by operating respective types of buttons secured on the control panel 300, it is possible to set detailed operation modes of the scanner function and the printer function. Furthermore, it is also possible to set detailed operation modes from the computer via the interface PIF for peripheral devices.

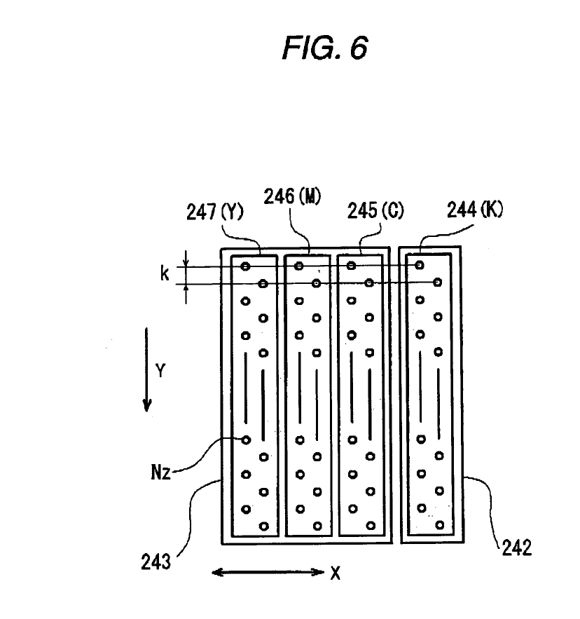

As shown in FIG. 6, a plurality of nozzles Nz for ejecting ink drops are formed on the printing heads 244 through 247 of respective colors. As shown, four sets of nozzle arrays which eject ink drops of respective colors are formed on the bottom face of the printing heads of respective colors. In one set of the nozzle arrays, 48 nozzles Nz are arrayed in a zigzag manner with a pitch k. Drive signals are supplied from the control circuit 260 to the respective nozzles Nz, and the respective nozzles Nz eject drops of respective ink in compliance with the drive signals.

As described above, the printer section 200 of the printing apparatus 10 supplies the driving signals to cause the nozzles to eject ink droplets to form ink dots on the printing medium P, thereby printing an image. Further, control data for driving the nozzles is generated by performing a prescribed image processing on the image data prior to printing of the image. Hereinafter, a description will be given for processing that generates control data by performing an image processing on image data and processing that forms ink dots on the basis of the obtained control data, thereby printing the image (image print processing).

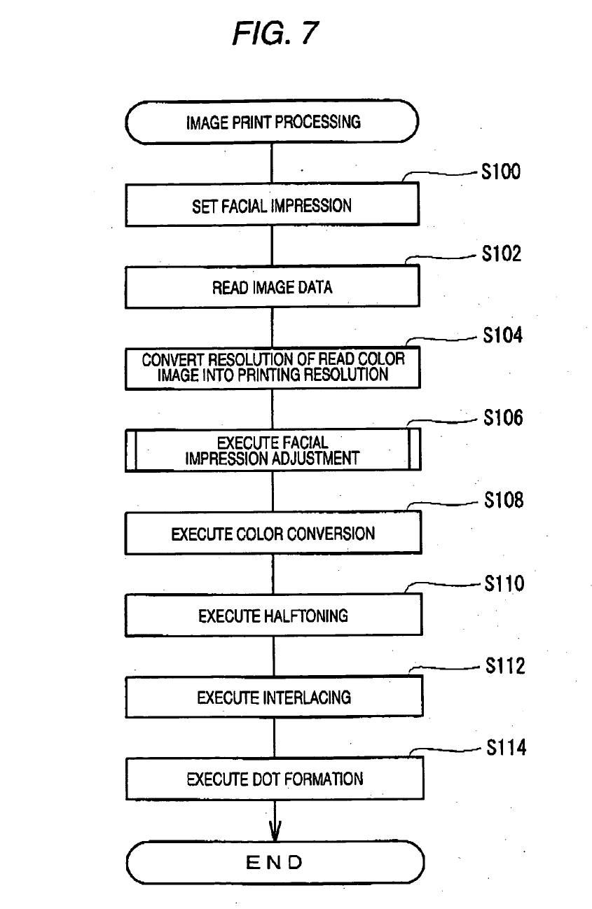

FIG. 7 shows the image print processing that is performed by the printing apparatus 10 in order to print an image. This processing is performed by the control circuit 260 mounted on the printing apparatus 10 using the internal CPU, RAM, or ROM. Hereinafter, the description will be given on the basis of the flowchart.

The control circuit 260 first performs a processing for setting an impression (facial impression) to be given by a human face, prior to starting the image print processing (Step S100). In the printing apparatus 10 of this embodiment, the facial impression can be set through a touch panel provided in the control panel 300.

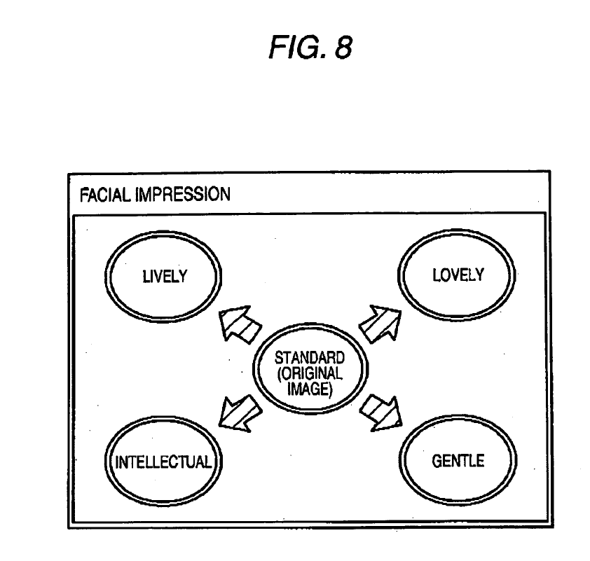

As shown in FIG. 8, four facial impressions of “lively”, “lovely”, “intellectual”, and “gentle” are prepared. When a portion corresponding to a desired facial impression is touched on the touch panel, the facial impression can be set. Moreover, when an original image is printed as it is without specifically setting the facial impression, a portion corresponding to “standard” is touched on the touch panel. The kinds of the facial impression to be prepared are not limited to the above facial impression, but more facial impressions can be prepared.

Next, the control circuit 260 reads image data to be printed (Step S102). Here, it is assumed that the image data is RGB image data represented by grayscale valves of the individual colors R, G, and B.

Thereafter, a processing for converting a resolution of the read image data into a resolution to be printed by the printer section 200 (printing resolution) is performed (Step S104). When the resolution of the read image data is lower than the printing resolution, an interpolation operation is performed between adjacent pixels and new image data is set, such that the resolution of the read image data is converted into a higher resolution. In contrast, when the resolution of the read image data is higher than the printing resolution, image data is thinned out from adjacent pixels at a prescribed ratio, such that the resolution of the read image data is converted into a lower resolution. In the resolution conversion processing, the processing for converting the read resolution into the printing resolution by generating or thinning out image data from the read image data at an appropriate ratio is performed.

After the resolution of the image data is converted into the printing resolution in such a manner, the control circuit 260 performs a processing for adjusting the image data (facial impression adjustment) such that the face of the human is printed to give the set impression (Step S106). The details of the facial impression adjustment will be described below, but the following steps are roughly performed. First, the image data is analyzed to extract a portion of the human face. Next, prescribed components of the face, such as eye, lip, and eyebrows, are detected from the extracted face. Then, the adjustment is performed on these components such that the face is printed to give the set impression.

After the image data is adjusted in such a manner, the control circuit 260 performs a color conversion processing (Step S108). Here, the color conversion processing converts the image data represented by the individual colors R, G, and B into image data represented by grayscale values of individual colors C, M, Y, and K. The color conversion processing is performed with reference to a three-dimensional numeric table, which is called a color conversion table (LUT).

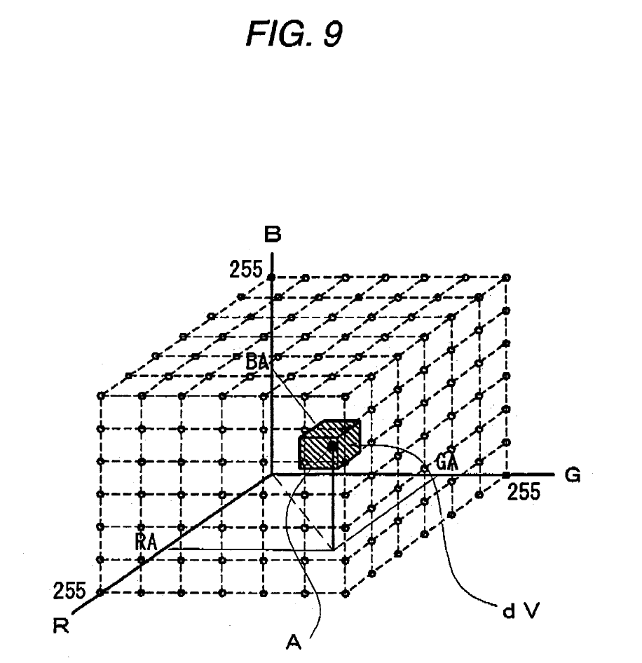

FIG. 9 shows a look-up table (LUT) to be referred to for the color conversion processing. Now, an RGB color space is taken into account, in which grayscale values of respective colors of R, G and B are taken in three axes orthogonal to each other as shown in FIG. 9, and it is assumed that the grayscale values of respective colors of RGB take values from 0 through 255. If so, all the RGB image data can be associated with an internal point of a cube (color solid), the original point of which is the top and the length of one side of which is 255. Therefore, changing the view point, if a plurality of lattice points are generated in the RGB color space by fragmenting the color solid in the form of a lattice orthogonal to the respective axes of RGB, it is considered that respective lattice points correspond to the RGB image data respectively. Therefore, combinations of grayscale values corresponding to the use amounts of ink of respective colors of C, M, Y and K are stored in advance in the respective lattice points. Thereby, the RGB image data can be quickly converted to image data corresponding to the use amounts of respective colors of ink (CMYK image data) by reading the grayscale values stored in the lattice points.

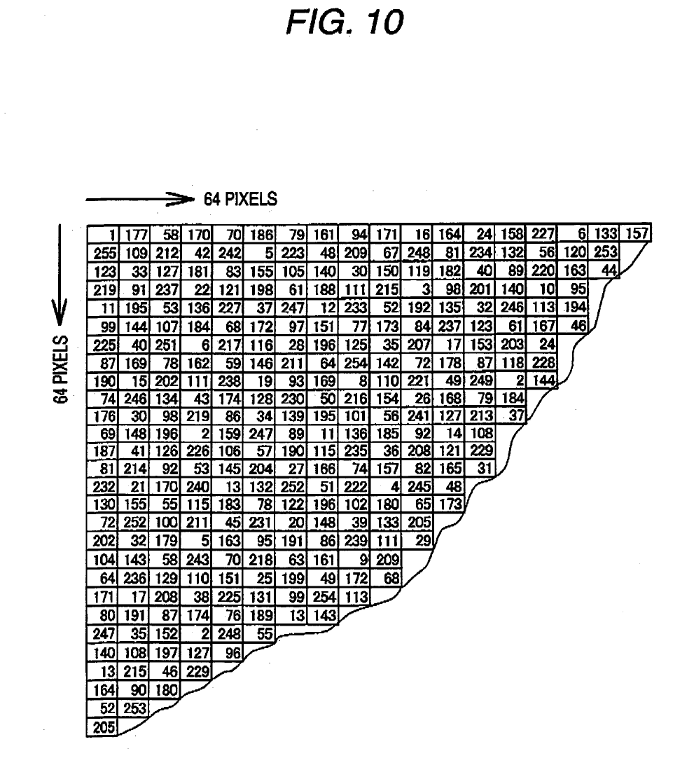

For example, if it is assumed that the R component of the image data is RA, the G component thereof is GA and the B component thereof is BA, the image data are associated with the point A in the RGB color space (refer to FIG. 10). Therefore, a cube dV having the point A included therein is detected from minute cubes which is fragmented from the color solid, the grayscale values of respective colors of ink, which are stored in the respective lattice points of the cube dV, are read. And, it is possible to obtain the grayscale value of the point A by executing an interpolation calculation based on the grayscale values the respective lattice points. As described above, it can be considered that the look-up table (LUT) is a three-dimensional numerical table in which combinations of grayscale values corresponding to the use amounts of ink of respective colors of C, M, Y and K are stored in a plurality of lattice points established in the RGB color space. And, by referencing the look-up table, it is possible to quickly convert the RGB image data in terms of color.

After the color conversion processing is terminated as described above, a halftoning is executed in the image copy processing shown in FIG. 7 (Step S110). The gradation data corresponding to the use amounts of ink of respective colors of CMYK obtained by the color conversion processing are data which can take a value from the grayscale value 0 through the grayscale value 255 per pixel. To the contrary, in the printer section 200, the printer section takes only a status on whether or not a dot is formed, with attention directed to individual pixels since the printer section 200 prints an image by forming dots. Therefore, it is necessary to convert the CYMK gradation data having 256 gradations to data (dot data) showing whether or not a dot is formed per pixel. The halftoning is a processing for converting the CMYK gradation data to dot data.

As a method for executing the halftoning; various types of methods such as an error diffusion method and a dither method may be employed. The error diffusion method diffuses the error in gradation expression generated in a certain pixel, by judging whether or not dots are formed in regard to the pixel, to the peripheral pixels, and at the same time, judges whether or not dots are formed in regard to respective pixels, so that the error diffused from the periphery can be dissolved. Also, the dither method compares the threshold values set at random in a dither matrix with the CMYK gradation data per pixel, and, for pixels in which the CMYK gradation data are greater, judges that dots are formed, and for pixels in which the threshold value is greater, judges that no dot is formed, thereby obtaining dot data for the respective pixels. As the halftoning, either the error diffusion method or the dither method can be used. In the printing apparatus 10 of this embodiment, it is assumed that the halftone processing is performed using the dither method.

FIG. 10 shows a part of the dither matrix. In the illustrated matrix, threshold values universally selected from the range of the grayscale values 0 through 255 are stored at random in 4096 pixels consisting of 64 pixels disposed in both the vertical and horizontal directions. Herein, the reason why the grayscale values of the threshold values are selected in the range of 0 through 255 corresponds to that the CMYK image data is of 1 byte in the embodiment, and the grayscale value takes a value from 0 through 255. In addition, the size of the dither matrix is not limited to 64 pixels in both the vertical and horizontal directions as shown in FIG. 10, but may be set to various sizes including a case in which the number of pixels differs in the vertical and horizontal directions.

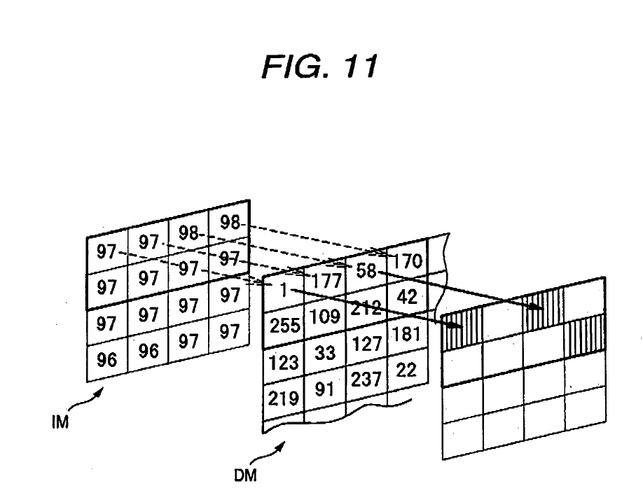

FIG. 11 shows how to judge whether or not dots are formed per pixel with reference to the dither matrix Such judgment is made for respective colors of CMYK. However, hereinafter, to avoid complicated description, the CMYK image data are handled merely as image data without distinguishing respective colors of the CMYK image data.

When judging whether or not dots are formed, first, the grayscale value of the image data IM for a pixel to which attention is focused as an object to be judged (pixel of interest) is compared with the threshold value stored in the corresponding position in the dither matrix DM. The arrow of a dashed line, which is shown in the drawing, schematically expresses that the image data of the noted pixel are compared with the threshold value stored in the corresponding position in the dither matrix. Where the image data of the noted image is greater than the threshold value of the dither matrix, it is judged that a dot is formed for the pixel. To the contrary, where the threshold value of the dither matrix is greater than the other, it is judged that no dot is formed for the pixel. In the example shown in FIG. 11, the image data of the pixel located at the left upper corner of the image is “97”, and the threshold value stored in the position corresponding to the pixel in the dither matrix is “1”. Therefore, since, on the pixel located at the left upper corner, the image data are greater than the threshold value of the dither matrix, it is judged that a dot is formed for the pixel. The arrow of a solid line shown in the FIG. 11 schematically expresses the state that the result of judgment is written in a memory upon judging that a dot is formed.

On the other hand, in regard to a pixel adjacent to this pixel at the right side, the image data are “97”, and the threshold value of the dither matrix is “177”, wherein the threshold value is greater than the other. Therefore, it is judged that no dot is formed. Thus, by comparing the image data with the threshold value set in the dither matrix, it is possible to determine, at respective pixels, whether or not dots are formed. In the haltftoning (Step S110 in FIG. 7), the above-described dither method is applied to the gradation data corresponding to the use amounts of respective ink of C, M, Y and K, whereby the processing of generating dot data is executed while judging, for each of the pixels, whether or not dots are formed.

After the gradation data of the respective colors of CMYK are converted to dot data, an interlacing is executed (Step S112). The interlacing re-arranges the dot data in the order along which the head unit 241 forms dots, and supplies the data to the printing heads 244 through 247 of the respective colors. That is, as shown in FIG. 6, since the nozzles Nz secured at the printing heads 244 through 247 are provided in the secondary scanning direction Y with the interval of nozzle pitch k spaced from each other, if ink drops are ejected while causing the printer carriage 240 to be subjected to primary scanning, dots are formed with the interval of nozzle pitch k spaced from each other in the secondary scanning direction Y. Therefore, in order to form dots in all the pixels, it is necessary that the relative position between the head 240 and a printing medium P is moved in the secondary scanning direction Y, and new dots are formed at pixels between the dots spaced only by the nozzle pitch k. As has been made clear from this, when actually printing an image, dots are not formed in the order from the pixels located upward on the image. Further, in regard to the pixels located in the same row in the primary scanning direction X, dots are not formed by one time of primary scanning, but dots are formed through a plurality of times of primary scanning based on the demand of the image quality, wherein it is widely executed that dots are formed at pixels in skipped positions in respective times of primary scanning.

Thus, in a case of actually printing an image, since it does not mean that dots are formed in the order of arrangement of pixels on the image, before actually commencing formation of dots, it becomes necessary that the dot data obtained for each of the colors of C, M, Y and K are rearranged in the order along which the printing heads 244 through 247 form the same. Such a processing is called an “interlacing.”

In the image copy processing, after the interlacing is completed, a processing of actually forming dots on a printing medium P (dot formation) is executed by the control circuit 260 based on the data obtained by the interlacing (Step S114). That is, while causing the printer carriage 240 to be subjected to primary scanning by driving the carriage motor 230, the dot data (printing control data) whose order has been rearranged are supplied to the printing heads 244 through 247. As a result, the ink droplets are ejected from the ink ejection heads 244 through 247 according to the dot data, and the dots are appropriately formed at each pixel.

After one time of primary scanning is completed, the printing medium P is fed in the secondary scanning direction Y by driving the medium feeding motor 235. After that, again, the dot data (printing control data) whose order has been re-arranged are supplied to the printing heads 244 through 247 to form dots while causing the printer carriage 240 to be subjected to primary scanning by driving the carriage motor 230. By repeating such operations, dots of respective colors of C, M, Y and K are formed on the printing medium P at a proper distribution responsive to the grayscale values of the image data. As a result, the image is printed.

In the above-described image print processing, if necessary, the image data is adjusted through the facial impression adjustment. Accordingly, it is possible to prevent the human face from giving an inappropriate impression due to an influence of how light enters, and it is possible to print an image that constantly gives a desired appropriate impression. Hereinafter, the details of the facial impression adjustment to be performed in the above-described image print processing will be described.

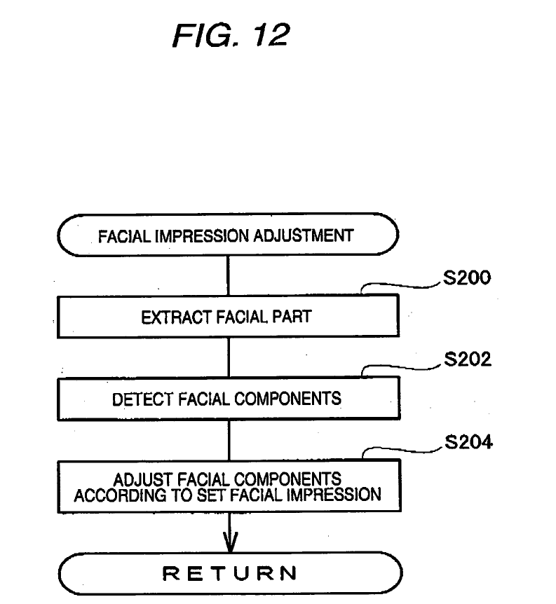

As shown in FIG. 12, in the facial impression adjustment, first, a processing for analyzing the image data and extracting the portion of the human face is performed (Step 8200). As a method of extracting the portion of the face, various methods are suggested, but the portion of the face can be roughly extracted by the following method.

First, a contour of objects is extracted from the image data. In order to extract the contour, noise is removed using a two-dimensional filter, such as a median filter or the like, contrast or edge is highlighted, and binarization is performed. Then, a boundary of the obtained binarized image is extracted as the contour of the object. Next, a processing for excluding, from the extracted contour, a portion to be clearly considered that does not correspond to the human face is performed. For example, an object having a high proportion of a straight line in the extracted contour is likely to be an artifact, not the human face. In such a manner, an object to be clearly judged that it is not the human face is excluded, objects to be considered as “eyes”, “mouth”, and “nose” are extracted from the contour of the remaining objects.

If the objects are actually “eyes”, “mouth”, and “nose”, they are supposed to a prescribed positional relationship. For example, when an object to be considered as “mouth” is extracted, if an object that can be judged as “eyes” or “nose” (or an object that can be clearly judged as “eyes” or “nose”) exists upward, it can be judged that the extracted object is “mouth”. Similarly, if an object to be considered as “eyes” is actually “eyes”, in many cases, an object to be as “eyes” of the same sense may exist at a short distance. In such a manner, the objects to be considered as “eyes”, “mouth”, and “nose” are extracted from the contour, and then “eyes”, “mouth”, and “nose” can be specified in consideration with the positional relationship between the extracted objects. Finally, if the contour of the face including a set of “eyes”, “mouths”, and “nose” is extracted, the portion of the human face in the image can be extracted.

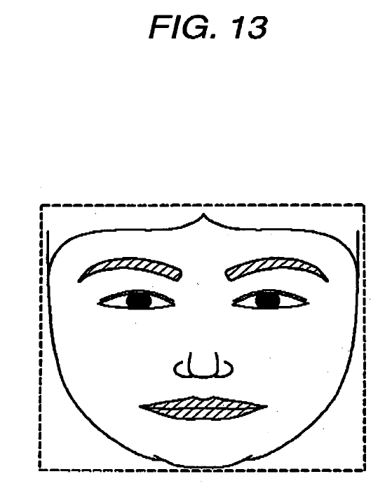

FIG. 13 shows a case where the portion of the human face is extracted from the image in the above-described manner. A rectangular region indicated by a dashed line in FIG. 13 becomes a region of the human face. At Step S200 of FIG. 12, the processing for extracting the facial portion in the above-described manner is performed.

After the facial portion is extracted in the above-described manner, a processing for detecting prescribed components, such as eyes, lips, eyebrows, and cheeks, in the extracted face starts (Step S202). Of course, other portions (for example, cheekbone, forehead, and chin) of the face may be detected as components.

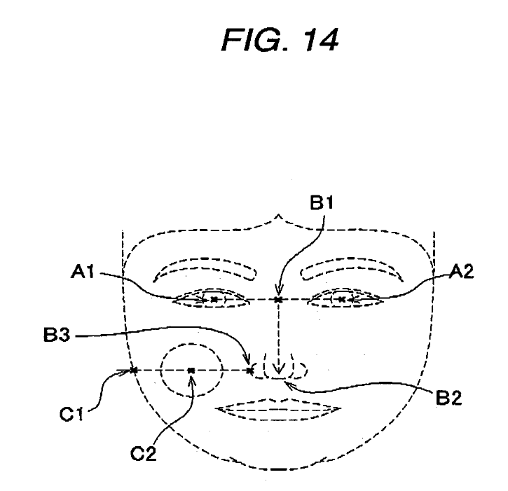

As shown in FIG. 14, the position of the eyebrows is first detected on the basis of the position of the eye detected previously. In general, the contour or color of the eyebrows is not clear compared with the eyes, and it is not easy to accurately detect only the eyebrows. In this case, however, the eyebrow can be relatively easily detected by detecting upward on the basis of the position of the eye, The position of the cheeks is detected as follows. First, a center point B1 between the positions of the left and right eyes (a point A1 and a point A2 of FIG. 14) is detected, and this position is supposed to a position of the base of the nose. Then, a position (a point B2 of FIG. 14) of a tip of the nose is detected downward from the position (a point B1 of FIG. 14) of the base of the nose, and sides are searched, such that the position (a point B3 of FIG. 14) of the nostril is detected. It is relatively difficult to accurately a nostril since it is likely to have an unclear contour. In this case, however, if the search is performed on the basis of the position of the tip of the nose, even the position of the nostril can be relatively accurately detected, Next, the search is performed from the position (the point B3) of the nostril in a horizontal direction, the contour (a point C1 of FIG. 14) of the face is detected, and a center point C2 between the nostril (the point B3) and the contour (the point C1) of the face is supposed to a center position of the cheek. The size of the cheek can be determined at a prescribed ratio on the basis of a distance from the center point C2 to the contour (the point C1) of the face. At Step S202 of FIG. 12, the processing for detecting the prescribed components from the extracted face in the above-described manner is performed.

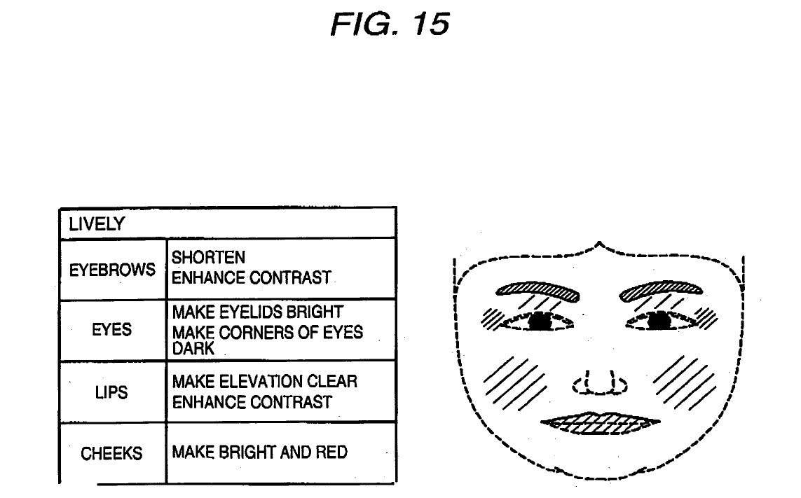

Next, a processing for adjusting the components according to a prescribed facial impression is performed (Step S204). As described above, in the printing apparatus 10 of this embodiment, four impressions of “lively”, “lovely”, “intellectual”, and “gentle” are prepared, and the adjustment items relative to each component according to the individual facial impressions are stored in the ROM of the control circuit 260. Then, the adjustment items according to the set facial impression are read out, and the processing for adjusting the facial components is performed. Hereinafter, the adjustment items of each component will be specifically described with reference to FIGS. 15 through 18.

In a left half of each of these drawings, the adjustment items relative to the facial components “eyebrows”, “eyes”, “lips”, and “cheeks” are collectively shown in a table. In a right half of each of these drawings, the facial components of the extracted face to which the adjustment items have been applied are shown.

When the facial impression is set to “lively”, as shown in FIG. 15, an adjustment that makes the “eyebrows” short and highlights the contrast is performed. Further, for the “eyes”, an adjustment that increases brightness of an eyelid and decreases brightness of an outer corner of the eye is performed. For the “lips”, a contour of an upper lip is highlighted to make the elevation thereof clear and contrast of the entire lip is highlighted. In addition, for the “cheeks”, an adjustment that increases brightness and the color is tinged with red is performed. When the “eyebrows” is made short and the “cheeks” is made bright and red, a young impression is given. When the contrast of the “eyebrows” or “lips” is highlighted, the eyelid is made bright, and the outer corner of the eye is made dark, a firm impression is given. As a result, the facial impression can look lively and fresh as a whole. Moreover, as regards the adjustment of brightness or color, it is preferable to perform the adjustment while shading off a boundary from the periphery, such that the adjusted portion is inconspicuous.

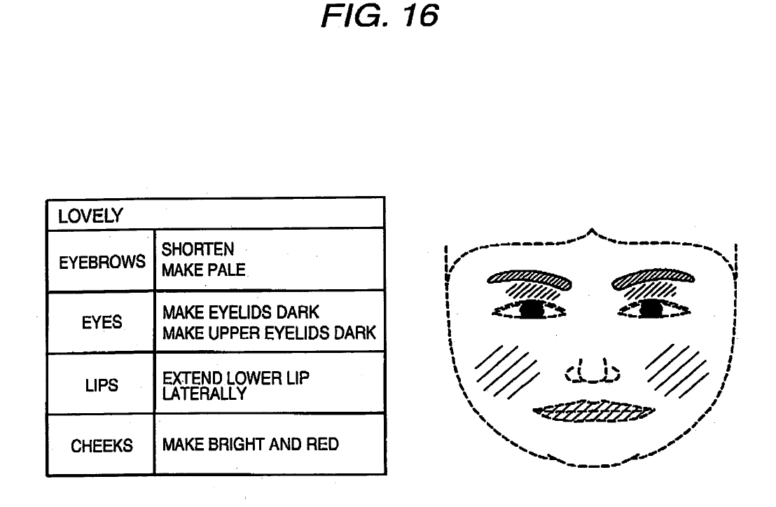

When the facial impression is set to “lovely”, as shown in FIG. 16, an adjustment that makes the “eyebrows” short and its color light is performed. Further, for the “eyes”, an adjustment that decreases brightness of the eyelid, in particular, an upper eyelid (a boundary between the eyelid and the eye) is performed. For the “lips”, the lower lip is adjusted to slightly extend laterally. At this time, it is preferable to perform the adjustment such that a position of a mouth corner does not move or to shade off the mouth corner such that a misalignment with a mouth corner of the upper lip is inconspicuous. In addition, an adjustment that increases brightness of the “cheeks” and tinges the color with red is performed. When the adjustment that makes the “eyebrows” short and the “cheeks” bright and red is performed, a young impression is given. Further, when the color of the “eyebrows” is made light, the eyelid is made dark, and the lower lip extends laterally, a gentle impression is given. In particular, when the upper eyelid is made dark, the eye looks bigger. As a result, the facial impression can be lovely as a whole.

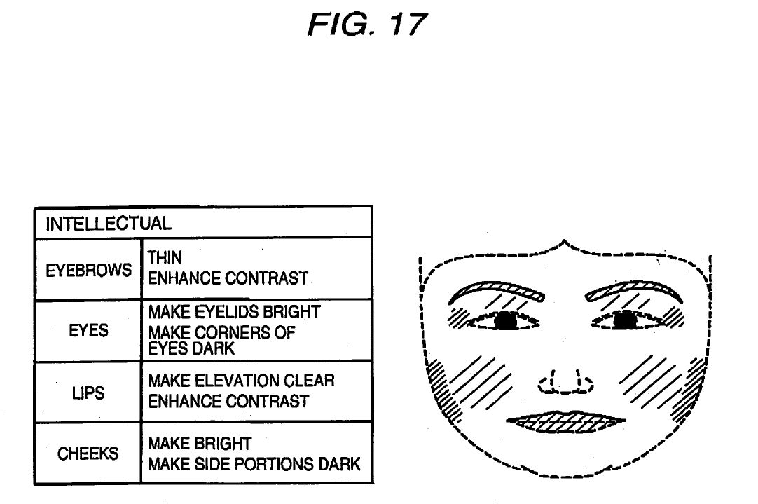

When the facial impression is set to “intellectual”, as shown in FIG. 17, an adjustment that makes the “eyebrows” thin and highlights the contrast is performed. At this time, when the width of the eyebrows with respect to the entire length of the eyebrows is detected, and it is judged that the eyebrows has been made thin already, the eyebrows may not be made thin any more. Further, for the “eyes”, an adjustment that increases brightness of the eyelid and decreases brightness of the outer corner of the eye is performed. For the “lips”, an adjustment that highlights the contour of the upper lip to make the elevation thereof clear, and highlights the contrast of the entire lip is performed. In addition, brightness of the “cheeks” increases and brightness of a contour of the face lateral to the cheeks decreases. When the “eyebrows” is made thin, a feminine impression can be given. Further, when the “cheeks” is made bright and red, a young impression can be given. In addition, when the contrast of the “eyebrows” or “lips” is highlighted, the eyelid is made bright, and the outer corner of the eye or the side of the cheeks is made dark, a firm impression can be given. As a result, the facial impression can be intellectual as a whole.

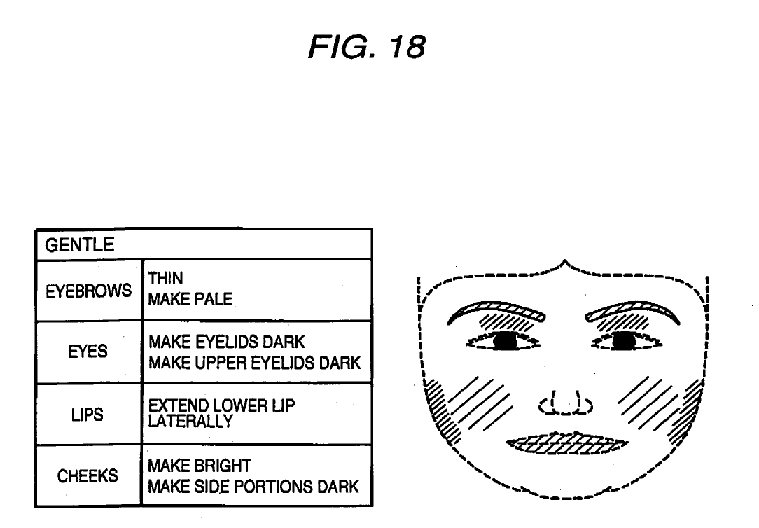

When the facial impression is set to “gentle”, as shown in FIG. 18, an adjustment that makes the “eyebrows” thin and the color of the eyebrows light is performed. For the “eyes”, an adjustment that decreases brightness of the eyelid, in particular, the upper eyelid is performed. Further, for the “lips”, an adjustment that slightly extends the lower lip laterally is performed. In addition, brightness of the “cheeks” increases and brightness of the contour of the face lateral to the cheeks decreases. When the “eyebrows” is made thin, a feminine impression is given. Further, when the color of the eyebrows is made light, the eyelid is made dark, and the lower lip extends laterally, a gentle impression is given. In addition, when the upper eyelid is particularly made dark, the eye looks bigger. Meanwhile, when the side of the cheeks is made dark, a firm impression can be given. As a whole, the facial impression can be feminine.

At Step S204 shown in FIG. 12, the processing that adjusts the prescribed components of the face in the above-described manner is performed. After the adjustment of the components is finished in such a manner, the facial impression adjustment shown in FIG. 12 is finished, and then the process returns to the image print processing for FIG. 7. As described above, in the image printing apparatus, the color conversion (Step S108), the halftoning (Step S110), the interlacing (Step S112), and the dot formation (Step S114) are performed on the image data subjected to the facial adjustment. Then, the ink dots are formed on the printing medium, and the image is printed.

If an image is printed using the printing apparatus 10 of this embodiment described above, a desired impression is prescribed, and then the human face can be printed to give a desired appropriate impression. Accordingly, an image that gives an appropriate impression can be obtained according to the purposes of a printed image. For example, when an image is used in a resume, an image having an intellectual impression is desirable. Further, when an image is given to a bridegroom, an intellectual image would be inappropriate since it may give tightness. In this case, an image of a feminine or gentle impression is desirable. According to the printing apparatus 10 of this embodiment, an image can be printed to give an appropriate impression according to the purposes.

In this embodiment, a desired facial impression is selected among a plurality of prescribed facial impressions. However, a plurality of facial impressions may be combined with certain proportions. Hereinafter, such a configuration will be described as a second embodiment of the invention.

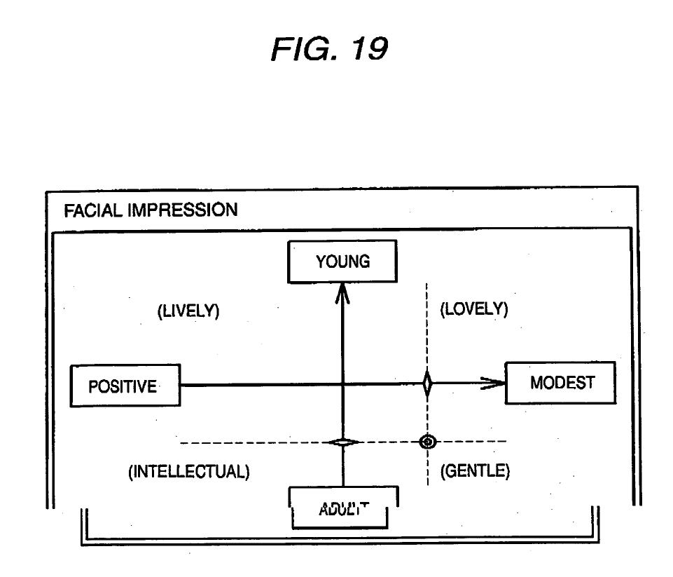

Also in this embodiment, the facial impression is set on the screen provided in the control panel 300, As shown in FIG. 19, two coordinate axes are provided on the screen, and opposing facial impressions (for example, “positive” and “modest” or “young” and “adult”) are set in positive and negative directions of each axis, respectively. Further, a handle is provided in each coordinate axis, and the coordinate value on the coordinate axis can be set by moving the position of the handle. In the example shown in FIG. 19, for a coordinate axis in a left and right direction in which the facial impressions of “positive” and “modest” are allocated, the position of the handle is set on a side of “positive”. Further, for a coordinate axis in an up and down direction in which the facial impression of “young” and “adult”, the position of the handle is set on a side of “adult”. As a result, a positive and adult impression, as a whole, an intellectual impression is set. Further, when it is felt that the positive impression or the adult impression is excessive, a desired can be set by adjusting the position of the handle. In this embodiment, the adjustment of the facial components (in this case, eyebrows, eye, lip, and cheeks) is performed on the basis of the facial impression set in such a manner.

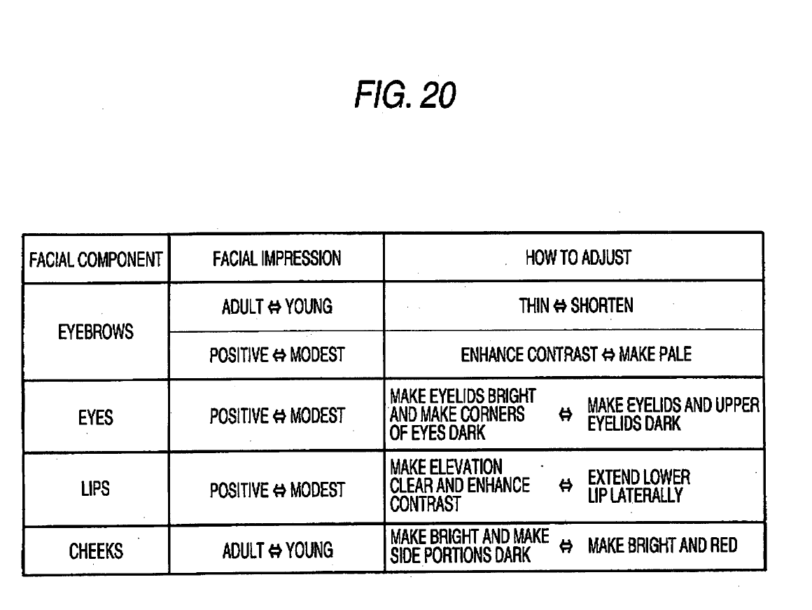

FIG. 20 shows how are the components adjusted according to the set facial impression. The coordinate value of the coordinate axis in the up and down direction allocated with the facial impressions of “young” and “adult” are adjusted to be reflected in the “eyebrows” and “cheeks”. That is, as the coordinate value leans toward “adult”, the eyebrows is made thin, the cheeks is bright, and the side of the cheeks is made dark. In contrast, as the coordinate value leans toward “young”, the eyebrows is made short, and the cheeks is made bright and red. Further, the coordinate value of the coordinate axis in the left and right direction allocated with the facial impressions of “positive” and “modest” are adjusted to be reflected in the “eyebrows”, “eyes”, and “lips”. That is, as the coordinate value leans toward “positive”, the contrast of the eyebrows or the lip is highlighted, the elevation of the lip is made clear, the eyelid is made bright, and the outer corner of the eye is made dark, In contrast, as the coordinate value leans toward “modest”, the color of the eyebrows is made light, the eyelid, in particular, the upper eyelid, is made dark, and the lower lip extends laterally. In such a manner, if the facial components are adjusted according to the position of the handle set on the individual coordinate axes, a facial impression close to a desire of a user can be set. As a result, a human can be printed to give an appropriate impression.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

The disclosure of Japanese Patent Application No. 2006-1$611 filed Jan. 23, 2006 including specification, drawings and claims is incorporated herein by reference in its entirety.

What is claimed is:

1. A printing method, comprising:
receiving image data obtained by capturing an image including a human,
designating a facial impression which is given by a human face;
detecting a prescribed component of a human face included in the image data;
adjusting a part of the image data corresponding to the prescribed component in accordance with the designated facial impression to obtain adjusted image data; and
printing an image based on the adjusted image data.

2. The printing method as set forth in claim 1, further comprising:
analyzing the image data and extracting a part of the image including the human face, wherein the prescribed component is detected in the extracted human face.

3. The printing method as set forth in claim 1, wherein:
the facial impression is designated by selecting one of a plurality of facial impressions each of which is stored in a storage in advance.

4. The printing method as set forth in claim 1, wherein:
the facial impression is designated as a combination of values on a plurality of coordinate axes each of which represents opposite facial
impressions as positive and negative values.

5. A printing apparatus, comprising:
a receiver, operable to receive image data obtained by capturing an image including a human;
a designator, operable to designating a facial impression which is given by a human face;
a detector, operable to detect a prescribed component of a human face included in the image data;
an adjuster, operable to adjust a part of the image data corresponding to the prescribed component in accordance with the designated facial impression to obtain adjusted image data; and
a printing section, operable to print an image based on the adjusted image data.

6. An image processing method, comprising:
receiving image data obtained by capturing an image including a human;
designating a facial impression which is given by a human face;
detecting a prescribed component of a human face included in the image data;
adjusting a part of the image data corresponding to the prescribed component in accordance with the designated facial impression to obtain adjusted image data; and
generating control data adapted to be used in a printing apparatus, based on the adjusted image data.

7. An image processing apparatus, comprising:
a receiver, operable to receive image data obtained by capturing an image including a human;
a designator, operable to designating a facial impression which is given by a human face;
a detector, operable to detect a prescribed component of a human face included in the image data;
an adjuster, operable to adjust a part of the image data corresponding to the prescribed component in accordance with the designated facial impression to obtain adjusted image data; and
a generator, operable to generate control data adapted to be used in a printing apparatus, based on the adjusted image data.
